(19) United States
(12) Patent Application Publication
(10) Pub. No.: US 2014/0055356 A1
(43) Pub. Date: Feb. 27, 2014

(54) MOUSE WITH THERMOELECTRIC POWER

(71) Applicant: PRIMAX ELECTRONICS LTD., Neihu (TW)

(72) Inventor: Jian-Bin Wu, Taipei (TW)

(73) Assignee: PRIMAX ELECTRONICS LTD., Neihu (TW)

(21) Appl. No.: 13/653,172

(22) Filed: Oct. 16, 2012

(30) Foreign Application Priority Data
Aug. 24, 2012 (CN) 201210305538.4

(51) Int. Cl. G06F 3/033

(52) U.S. Cl. 345/163

(57) ABSTRACT

The present invention discloses a mouse with thermoelectric power including a mouse body, a switch, a button, a thermal conductive sheet and a thermoelectric power generation chip. The thermal conductive sheet passes through the button and contacts with the thermoelectric power generation chip located on an edge of a lower surface of the button, so as to ensure the thermal conductive sheet to be frequently touched by a user's finger and thus provide a temperature difference required for the thermoelectric power generation chip. Moreover, the heat generated by the thermoelectric power generation chip can further be dissipated through a gap formed around the edge of the button, so as to maintain the thermoelectric power generation chip at the maximum thermoelectric power generation efficiency.

### FIELD OF THE INVENTION

The present invention generally relates to a mouse device, and more particularly to a mouse device supplied power with a thermoelectric power generation chip.

### BACKGROUND OF THE INVENTION

Here in the technology and information age, the computer and peripherals thereof has become a part of the daily life of everybody, and an important of the mouse, which is used as the communication between the computer and the user, is unable to be understated. As a result, all of the major computer related industries in the market has paid considerable attention to the mouse and invented a plurality of mice with various new functions or much more convenient in use.

A kind of conventional mouse with thermoelectric power is already commercially available, wherein the electricity supplied to the mouse is generated by using a temperature difference principle. FIG. 1 illustrates a schematic view of an overall appearance and an operation status of a conventional mouse with thermoelectric power. Referring to FIG. 1, the conventional mouse with thermoelectric power 10 as illustrated in FIG. 1 comprises a mouse body 11, wherein a plurality of heat dissipation apertures 14 is formed on the mouse body 11, a thermal conductive sheet 12 is disposed at a rear end of the mouse body 11, and a thermoelectric power generation chip 13 is disposed on a lower surface of the thermal conductive sheet 12. As a palm 15 of a user contacts with the thermal conductive sheet 12, the heat coming from the palm 15 of the user is transmitted to a contact surface 131 of the thermoelectric power generation chip 13, so as to heat the contact surface 131 to a high temperature T1. In addition, thermoelectric power generation chip 13 further transforms a temperature difference between the high temperature T1 and an air temperature T2 inside the mouse body 11 as an output electricity, so as to provide the required electricity for operating the mouse with thermoelectric power 10. As a result, it is possible to activate the mouse with thermoelectric power 10 without using a battery.

Referring to FIG. 1 also, with regard to the mouse with thermoelectric power 10, it should be noted that the palm 15 of the user may be unable to contact with the thermal conductive sheet 12 disposed at the rear end of the mouse body 11 because different users may have different sizes of the palms 15, different operation habits, etc. As a result, it is probably unable to maintain enough electricity for operating the mouse with thermoelectric power 10 to some users. In addition, the plurality of heat dissipation apertures 14 formed on the mouse body 11 not only results in an appearance of the mouse with thermoelectric power 10 quite unsightly, but also is helpless to the heat dissipation efficiency of the air inside the mouse body 11 because the plurality of heat dissipation apertures 14 can merely enable the air to be transmitted into or out of an internal of the mouse body 11 rather than facilitates the air to flow and to dissipate the heat. As a result, for the mouse with thermoelectric power 10 unable to be generally suitable for various sizes of the palms 15 of the users and various operation habits, the thermoelectric power generation chip 13 thereof is frequently unable to provide enough output electricity because the high temperature T1 is too low and the air temperature T2 inside the mouse body 11 is not low enough. In such an instance, the conventional mouse with thermoelectric power 10 not only is unable to be operated but also has no battery to be replaced. As a result, the only solution is trying to deliberately touch the thermal conductive sheet 12 and to facilitate an air circulation between the inside and an outside of the mouse body 11 repeatedly, so as to enable the thermoelectric power generation chip 13 to accumulate the electricity until the electricity is enough to activate the mouse with thermoelectric power 10. As a result, such a design is quite inconvenient and troublesome to the users.

### SUMMARY OF THE INVENTION

The present invention is directed to providing a mouse device, and more particularly to providing a mouse device capable of supplying electricity by efficiently using a thermoelectric power generation chip.

In a preferred embodiment, the present invention provides a mouse with thermoelectric power, comprising:
a mouse body:
a switch, disposed within the mouse body;
a thermal conductive sheet, disposed on the mouse body, the thermal conductive sheet comprising a first surface and a second surface opposite to the first surface,
and the switch capable of being activated by pressing the first surface, wherein the thermal conductive sheet is capable of being heated to a first temperature by absorbing the heat from a finger put on the thermal conductive sheet;
a thermoelectric power generation chip, disposed on the second surface of the thermal conductive sheet, and capable of transforming a temperature difference between the first temperature and a reference temperature around the thermoelectric power generation chip into an output electricity.

In a preferred embodiment, a gap is formed between an edge of the thermal conductive sheet and the mouse body, and the thermoelectric power generation chip is disposed adjacent to the edge of the thermal conductive sheet.

In a preferred embodiment, the mouse with thermoelectric power further comprises an electricity storage device capable of storing the output electricity.

In a preferred embodiment, the electricity storage device is a rechargeable battery or a capacitance.

In a preferred embodiment, the mouse with thermoelectric power further comprises a voltage regulator capable of transforming a voltage and a current outputted from the electricity storage device into a stable voltage and a stable current.

In a preferred embodiment, the mouse with thermoelectric power further comprises a circuit board disposed inside the mouse body, and the thermoelectric power generation chip electrically connected with the circuit board.

In a preferred embodiment, the switch is capable of generating a left button signal.

In a preferred embodiment, the switch is capable of generating a right button signal.

In another preferred embodiment, the present invention provides a mouse with thermoelectric power, comprising:
a mouse body:
a switch, disposed inside the mouse body;
a button, disposed on the mouse body, the button comprises a first surface and a second surface opposite to the first surface, and the switch capable of being activated by pressing the first surface;
a thermal conductive sheet, disposed on the button and exposed by the first surface and the second surface, wherein the thermal conductive sheet is capable of being heated to a first temperature by absorbing the heat from a finger put on the thermal conductive sheet; and
a thermoelectric power generation chip, disposed on the second surface of the button, contacting with the thermal conductive sheet, and capable of transforming a temperature difference between the first temperature and a reference temperature around the thermoelectric power generation chip into an output electricity.

In another preferred embodiment, a gap is formed between an edge of the button and the mouse body, and the thermoelectric power generation chip is disposed adjacent to the edge of the button.

In another preferred embodiment, the mouse with thermoelectric power further comprises an electricity storage device capable of storing the output electricity.

In another preferred embodiment, the electricity storage device is a rechargeable battery or a capacitance.

In another preferred embodiment, the mouse with thermoelectric power further comprises a voltage regulator capable of transforming a voltage and a current outputted from the electricity storage device into a stable voltage and a stable current.

In another preferred embodiment, the mouse with thermoelectric power further comprises a circuit board disposed inside the mouse body, and the thermoelectric power generation chip electrically connected with the circuit board.

In another preferred embodiment, the switch is capable of generating a left button signal.

In another preferred embodiment, the switch is capable of generating a right button signal.

### BRIEF DESCRIPTION OF THE DRAWINGS

FIG. 1 illustrates a schematic view of an overall appearance and an operation status of a conventional mouse with thermoelectric power.

FIG. 2 illustrates a schematic view of an explosion and a cross-section of a main portion of a mouse with thermoelectric power according to a first preferred embodiment of the present invention.

FIG. 3 illustrates a schematic view of a cross-section and an operation status of the main portion of the mouse with thermoelectric power according to the first preferred embodiment of the present invention.

FIG. 4A illustrates a schematic view of a detail of the mouse with thermoelectric power according to the first preferred embodiment of the present invention.

FIG. 4B illustrates a schematic view of a cross-section of the main portion of the mouse with thermoelectric power according to the first preferred embodiment of the present invention.

FIG. 5A to FIG. 5D respectively illustrate a schematic view of a location of the thermoelectric power generation chip of the mouse with thermoelectric power according to the first preferred embodiment of the present invention.

FIG. 6 illustrates a schematic view of an electrical connection of the mouse with thermoelectric power according to the first preferred embodiment of the present invention.

FIG. 7 illustrates a schematic view of an explosion and a cross-section of a main portion of a mouse with thermoelectric power according to another preferred embodiment of the present invention.

FIG. 8A to FIG. 8D respectively illustrate a schematic view of a location of a thermoelectric power generation chip of a mouse with thermoelectric power according to another preferred embodiment of the present invention.

FIG. 9A to FIG. 9D respectively illustrates a schematic view of a location of a thermoelectric power generation chip of a mouse with thermoelectric power according to a further one preferred embodiment of the present invention.

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

In order to make up the above-mentioned disadvantages of the conventional mouse with thermoelectric power, both of the thermal conductive sheet and the thermoelectric power generation chip in the present invention are designed to a location equivalent to the button rather than disposing both of the thermal conductive sheet and the thermoelectric power generation chip illustrated in the conventional art at the rear end of the mouse body and forming the heat dissipation apertures thereon.

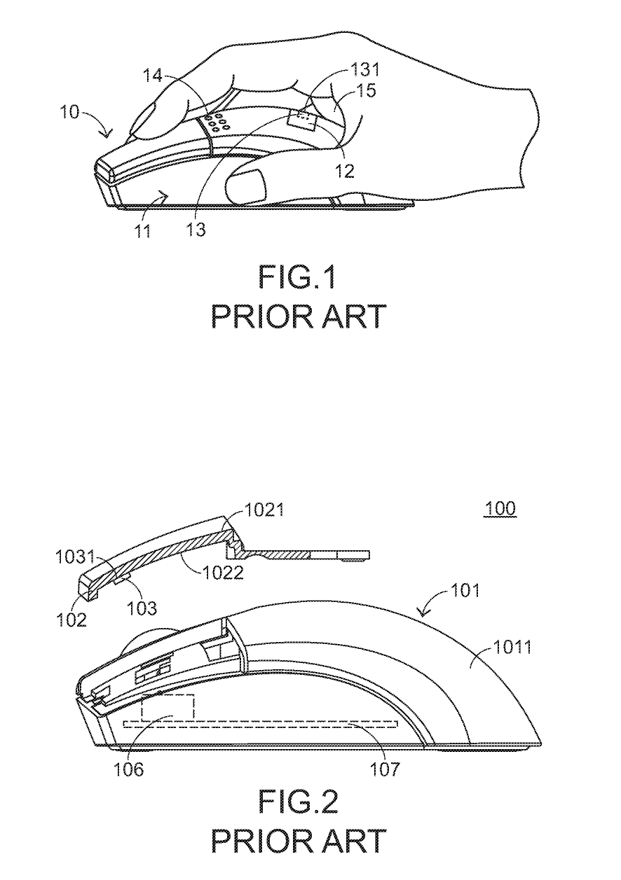

FIG. 2 illustrates a schematic view of an explosion and a cross-section of a main portion of a mouse with thermoelectric power according to a first preferred embodiment of the present invention. Referring to FIG. 2, the mouse with thermoelectric power 100 as illustrated in FIG. 2 comprises a mouse body 101 and a thermal conductive sheet 102, and a first surface 1021 of the thermal conductive sheet 102 extends toward a surface 1011 of the mouse body 101, so as to enable the thermal conductive sheet 102 to form whole of a contour of the mouse with thermoelectric power 100 together with the mouse body 101. A thermoelectric power generation chip 103, which is disposed on a second surface 1022 of the thermal conductive sheet 102, is capable of transforming a temperature difference into an output electricity, so as to provide the required electricity for operating the mouse with thermoelectric power 100.

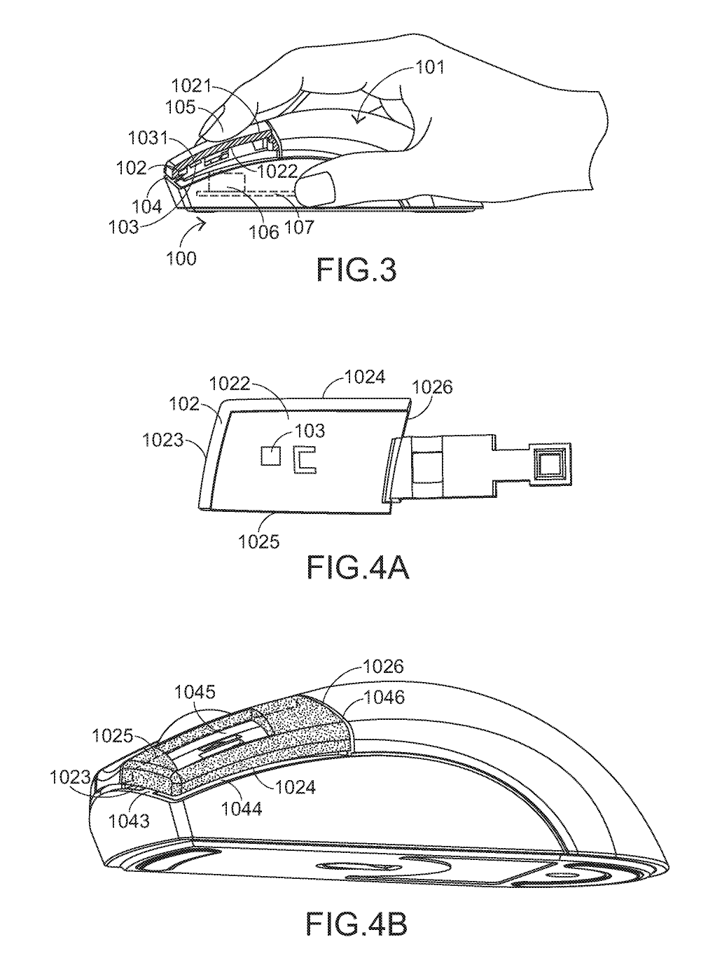

FIG. 3 illustrates a schematic view of a cross-section and an operation status of the main portion of the mouse with thermoelectric power according to the first preferred embodiment of the present invention. Referring to FIG. 3 further, a gap 104 as illustrated in FIG. 3 is formed between the thermal conductive sheet 102 and the mouse body 101, and the thermal conductive sheet 102 is formed by a structure capable of being pressed and automatically returning. When a user uses a finger 105 to press the first surface 1021 of the thermal conductive sheet 102 to lessen the gap 104, the thermal conductive sheet 102 travels downward to trigger a switch 106 under it, so as to generate an input signal, such as a left button signal or a right button signal.

In general, although different users may put their palms and fingers on the mouse with different ways due to their operation habits and the sizes of their palms, each of them will naturally put one finger on the button all the time for preparing to press the button for inputting a signal anytime. As a result, referring to FIG. 3 also, when the user naturally puts his finger 105 on the first surface 1021 of the thermal conductive sheet 102 with a key function due to his operation habit, the finger 105 will be in thermal equilibrium with the thermal conductive sheet 102 and a contact surface 1031 of the thermoelectric power generation chip 103, so as to maintain both of the thermal conductive sheet 102 and the contact surface 1031 of the thermoelectric power generation chip 103 at a first temperature T11 higher than the ambient temperature, so that the thermoelectric power generation chip 103 can continuously transform a temperature difference between the first temperature T11 and a reference temperature T12 around the thermoelectric power generation chip 103 into an output electricity.

Referring to FIG. 3 as well, the air around the thermoelectric power generation chip 103 can be circulated with the external air via the gap 104 originally formed between the thermal conductive sheet 102 and the mouse body 101 without additionally forming a heat dissipation aperture. As a result, a pleasing appearance of the mouse with thermoelectric power 100 can be maintained. In addition, when the user presses the thermal conductive sheet 102 for generating the input signal, a movement of the thermal conductive sheet 102 further compresses and disturbs the air around the thermoelectric power generation chip 103. In a word, the movement facilitates the air around the thermoelectric power generation chip 103 to circulate, so as to maintain the reference temperature T12 around the thermoelectric power generation chip 103 at a lower temperature close to the ambient temperature.

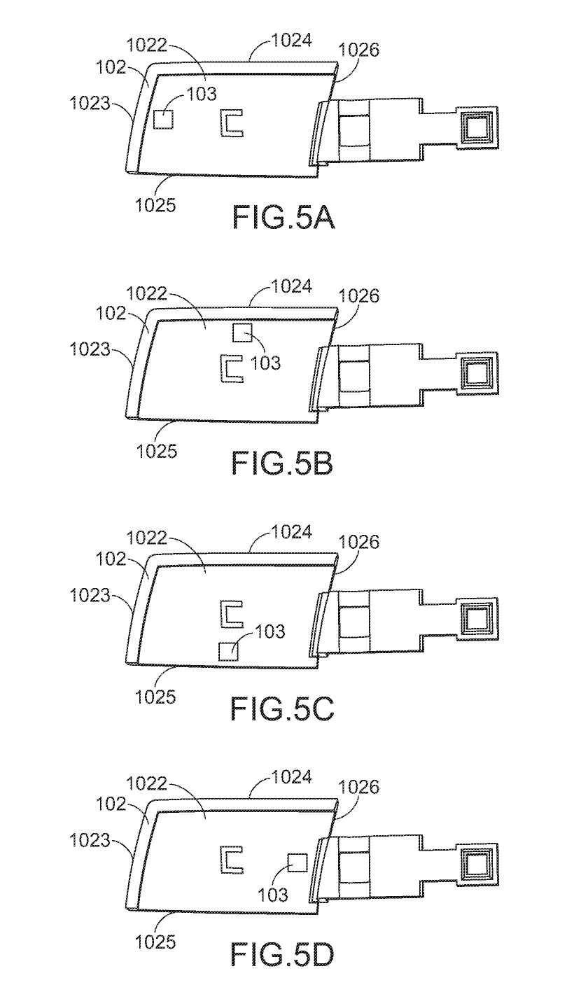

FIG. 4A illustrates a schematic view of a detail of the mouse with thermoelectric power according to the first preferred embodiment of the present invention, while FIG. 4B illustrates a schematic view of a cross-section of the main portion of the mouse with thermoelectric power according to the first preferred embodiment of the present invention. Referring to FIG. 4A and FIG. 4B together, the thermal conductive sheet 102 as illustrated in FIG. 4A and FIG. 4B comprises a plurality of edges, i.e. a first edge 1023, a second edge 1024, a third edge 1025 and a fourth edge 1026, respectively forming a gap with the mouse body 102, i.e. a first gap 1043, a second gap 1044, a third gap 1045 and a fourth gap 1046. Here, the thermoelectric power generation chip 103 can be disposed at any location on the second surface 1022 of the thermal conductive sheet 102. Preferably, referring to FIG. 5A to FIG. 5D, FIG. 5A to FIG. 5D respectively illustrate a schematic view of a location of the thermoelectric power generation chip of the mouse with thermoelectric power according to the first preferred embodiment of the present invention. Here, the thermoelectric power generation chip 103 is able to be disposed at a location on the second surface 1022 of the thermal conductive sheet 102 adjacent to any edge of the thermal conductive sheet 102, i.e. a location adjacent to the first edge 1023, adjacent to the second edge 1024, adjacent to the third edge 1025, adjacent to the fourth edge 1026 and so on. As a result, the air around the thermoelectric power generation chip 103 is maintained at a lower temperature almost the same as the ambient temperature because it is adjacent to the first gap 1043, the second gap 1044, the third gap 1045 or the fourth gap 1046 as shown in FIG. 4, so as to output the largest electricity by maximizing the temperature difference between the first temperature T11 and the reference temperature T12 around the thermoelectric power generation chip 103.

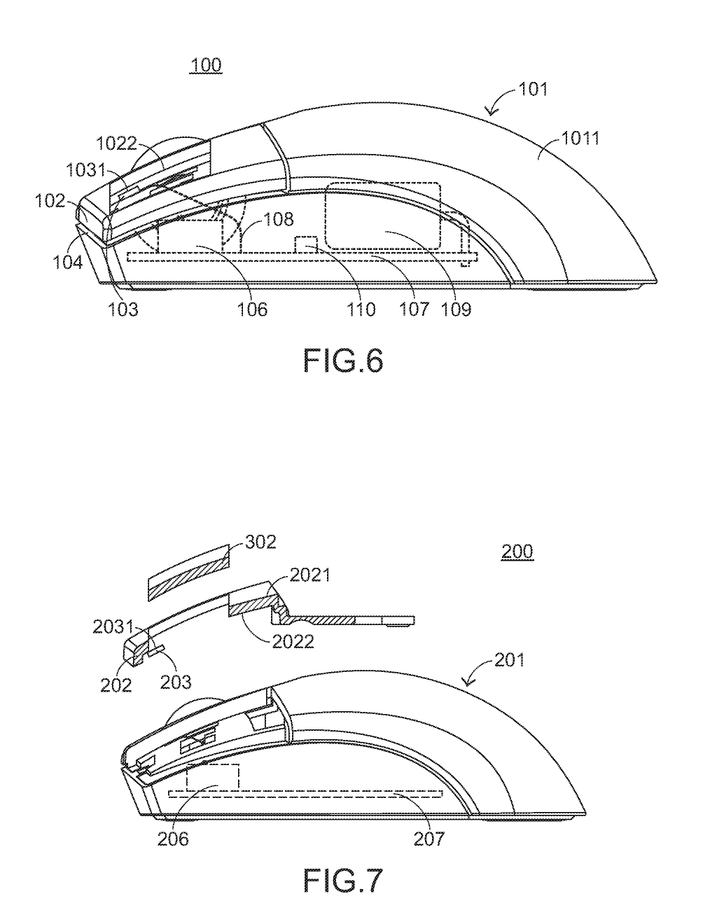

Next, an electrical connection status of the mouse with thermoelectric power of the present invention is further illustrated hereinafter. FIG. 6 illustrates a schematic view of an electrical connection of the mouse with thermoelectric power according to the first preferred embodiment of the present invention. Referring to FIG. 6, the thermoelectric power generation chip 103 as illustrated in FIG. 6 is electrically connected with a circuit board 107 inside the mouse body 101 via an electrical connection component 108, wherein the electrical connection component 108 can be practiced by, for example but not limited to, an elastic piece or a long circuit board disposed with a plurality of pins. Preferably, the circuit board 107 can also disposed with an electricity storage device 109 thereon, which is capable of storing the output electricity of the thermoelectric power generation chip 103. The electricity storage device 109 can be, for example but not limited to, a rechargeable battery or a capacitance. In addition, the circuit board 107 can further disposed with a voltage regulator 110 thereon, which is capable of transforming a voltage and a current outputted from the electricity storage device 109 into a stable voltage and a stable current, so as to provide a required stable electricity for operating the mouse with thermoelectric power 100.

The present invention provides another preferred embodiment of the mouse with thermoelectric power as well. Referring to FIG. 7, FIG. 7 illustrates a schematic view of an explosion and a cross-section of a main portion of a mouse with thermoelectric power according to another preferred embodiment of the present invention. As shown in FIG. 7, the mouse with thermoelectric power 200 comprises a mouse body 201, a button 202 and a thermal conductive sheet 302. The button 202 has a first surface 2021 and a second surface 2022, while the thermal conductive sheet 302 is disposed on the button 202 and exposed by the first surface 2021 and the second surface 2022. There is a thermoelectric power generation chip 203 disposed on the second surface 2022 of the button 202, which is capable of transforming a temperature difference into an output electricity. The button 202 is formed by a structure capable of being pressed and automatically returning. When a user uses a finger to press the first surface 2021 of the button 202, the button 202 travels downward to trigger a switch 206 under it, so as to generate an input signal, such as a left button signal or a right button signal.

The mouse with thermoelectric power 200 of the present invention and the mouse with thermoelectric power 100 of the present invention have the same main structures and operation theories, and the only difference therebetween is that all functions (including a key function and a conductive function) of the thermal conductive sheet 102 in the mouse with thermoelectric power 100 are together achieved by the button 202 of the mouse with thermoelectric power 200 and the thermal conductive sheet 302.

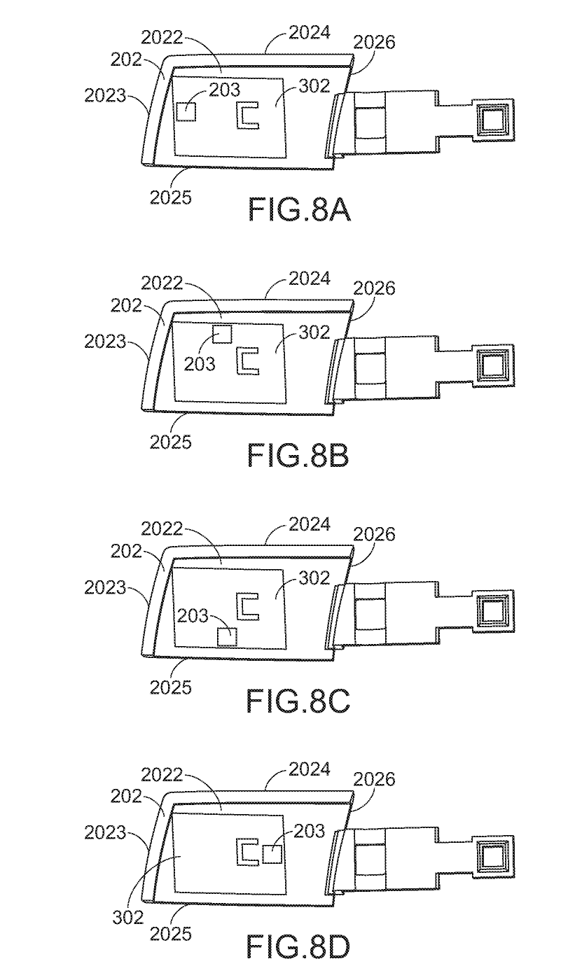

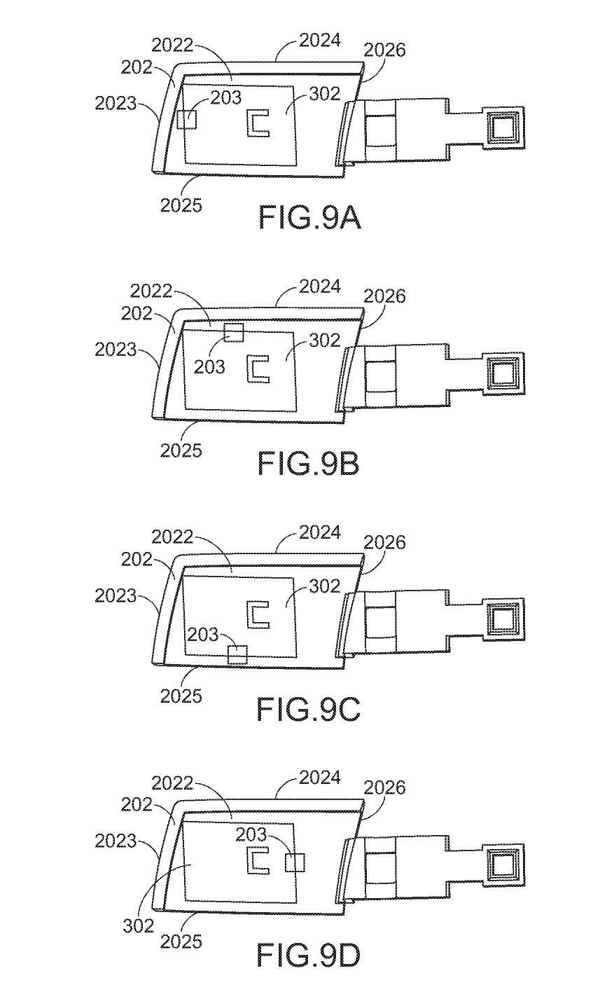

As the above illustrations described for the mouse with thermoelectric power 100, the thermoelectric power generation chip 203 of the mouse with thermoelectric power 200 can also be disposed at any location, where is located on the second surface 2022 of the button 202 and contacting with the thermal conductive sheet 302. Preferably, referring to FIG. 8A to FIG. 8D and FIG. 9A to FIG. 9D together, FIG. 8A to FIG. 8D and FIG. 9A to FIG. 9D illustrate a schematic view of a location of a thermoelectric power generation chip of a mouse with thermoelectric power according to another preferred embodiment of the present invention respectively. Here, the thermoelectric power generation chip 203 is able to be disposed at a location, where is located on the second surface 2022 of the button 202, contacting with the thermal conductive sheet 302 and adjacent to any edge of the button 202, i.e. a location adjacent to the first edge 2023, adjacent to the second edge 2024, adjacent to the third edge 2025, adjacent to the fourth edge 2026 and so on. As a result, the air around the thermoelectric power generation chip 203 is maintained at a lower temperature almost the same as the ambient temperature because it is adjacent to the gap.

In the present invention, the thermal conductive sheet and the thermoelectric power generation chip are disposed at the location equivalent to the button rather than not only disposing both of the thermal conductive sheet and the thermoelectric power generation chip at the rear end of the mouse body but also forming the heat dissipation apertures thereon as illustrated in the conventional art. As a result, the mouse with thermoelectric power of the present invention can not only prevent the disadvantage that the conventional mouse with thermoelectric power is not suitable for every user, but also additionally provide a better way for the heat dissipation, so as to ensure maintaining the temperature difference and thus continuously to output the electricity.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A mouse with thermoelectric power, comprising:
a mouse body:
a switch, disposed inside the mouse body;
a thermal conductive sheet, disposed on the mouse body, the thermal conductive sheet comprising a first surface and a second surface opposite to the first surface, and the switch capable of being activated by pressing the first surface, wherein the thermal conductive sheet is capable of being heated to a first temperature by absorbing the heat from a finger put on the thermal conductive sheet;
a thermoelectric power generation chip, disposed on the second surface of the thermal conductive sheet, and capable of transforming a temperature difference between the first temperature and a reference temperature around the thermoelectric power generation chip into an output electricity.

2. The mouse with thermoelectric power as claimed in claim 1, wherein a gap is formed between an edge of the thermal conductive sheet and the mouse body, and the thermoelectric power generation chip is disposed adjacent to the edge of the thermal conductive sheet.

3. The mouse with thermoelectric power as claimed in claim 1, further comprising an electricity storage device capable of storing the output electricity.

4. The mouse with thermoelectric power as claimed in claim 3, wherein the electricity storage device is a rechargeable battery or a capacitance.

5. The mouse with thermoelectric power as claimed in claim 3, further comprising a voltage regulator capable of transforming a voltage and a current outputted from the electricity storage device into a stable voltage and a stable current.

6. The mouse with thermoelectric power as claimed in claim 1, further comprising a circuit board disposed inside the mouse body, and the thermoelectric power generation chip electrically connected with the circuit board.

7. The mouse with thermoelectric power as claimed in claim 1, wherein the switch is capable of generating a left button signal.

8. The mouse with thermoelectric power as claimed in claim 1, wherein the switch is capable of generating a right button signal.

9. A mouse with thermoelectric power, comprising:
a mouse body:
a switch, disposed inside the mouse body;
a button, disposed on the mouse body, the button comprises a first surface and a second surface opposite to the first surface, and the switch capable of being activated by pressing the first surface;
a thermal conductive sheet, disposed on the button and exposed by the first surface and the second surface, wherein the thermal conductive sheet is capable of being heated to a first temperature by absorbing the heat from a finger put on the thermal conductive sheet; and
a thermoelectric power generation chip, disposed on the second surface of the button, contacting with the thermal conductive sheet, and capable of transforming a temperature difference between the first temperature and a reference temperature around the thermoelectric power generation chip into an output electricity.

10. The mouse with thermoelectric power as claimed in claim 9, wherein a gap is formed between an edge of the button and the mouse body, and the thermoelectric power generation chip is disposed adjacent to the edge of the button.

11. The mouse with thermoelectric power as claimed in claim 9, further comprising an electricity storage device capable of storing the output electricity.

12. The mouse with thermoelectric power as claimed in claim 11, wherein the electricity storage device is a rechargeable battery or a capacitance.

13. The mouse with thermoelectric power as claimed in claim 11, further comprising a voltage regulator capable of transforming a voltage and a current outputted from the electricity storage device into a stable voltage and a stable current.

14. The mouse with thermoelectric power as claimed in claim 9, further comprising a circuit board disposed inside the mouse body, and the thermoelectric power generation chip electrically connected with the circuit board.

15. The mouse with thermoelectric power as claimed in claim 9, wherein the switch is capable of generating a left button signal.

16. The mouse with thermoelectric power as claimed in claim 9, wherein the switch is capable of generating a right button signal.
